(19) United States
(12) Patent Application Publication
(10) Pub. No.: US 2016/0098720 A1
(43) Pub. Date: Apr. 7, 2016

(54) QUICK SERVICE TERMINAL FOR IDENTIFYING CUSTOMERS USING LEGACY CUSTOMER IDENTIFICATION INSTRUMENTS

(71) Applicant: Bank of America Corporation, Charlotte, NC (US)

(72) Inventors: Michelle Bentubo, Orlando, FL (US); Debashis Choudhury, Dallas, TX (US); Elizabeth Anne Price, Newport, TN (US)

(21) Appl. No.: 14/508,076

(22) Filed: Oct. 7, 2014

(51) Int. Cl. G06Q 20/40

(52) U.S. Cl. CPC G06Q 20/4012

(57) ABSTRACT

Apparatus for providing a QST are disclosed herein. The QST may identify a customer in response to a swipe of a customer identifying instrument. The QST may include a reading head, a processor, a keypad, and a communications medium. The reading head may detect identification information in response to the swipe of the instrument. The identification information may be associated with a personal identification instrument. The processor may bypass a PIN acceptance state and perform a search for at least one banking record corresponding to the personal identification instrument. The processor may terminate the identification session in response to failure to obtain a record corresponding to the identification instrument. In response, at least in part, to identification of at least one record that corresponds to the personal identification instrument, the communications medium may receive a session-auth instruction from a remote location. The session-auth instruction may initiate a banking session.

### FIELD OF TECHNOLOGY

The disclosure relates to quick service terminals (“QST”). QSTs may be used to quickly and easily identify individuals.

### BACKGROUND OF THE DISCLOSURE

QSTs may be used to accept and identify a magnetic strip (“mag-stripe”) located on banking cards. Following identification of the banking card, the QST may enter a personal identification number (“PIN”) acceptance state. In the PIN acceptance state, the QST may be configured to accept a PIN. If the PIN corresponds to the mag-stripe, then the QST, either by itself or in conjunction with software and/or hardware in the bank, may authorize a session to begin.

Typically, QSTs are not designed to accept identification documents other than banking cards. It would be desirable to provide a QST, and/or an electronic platform for supporting such a QST, that could be used with forms of identification other than banking cards.

### SUMMARY OF THE DISCLOSURE

Systems and methods for using a quick service terminal that is configured to identify a customer in response to a swipe of a customer identifying instrument are provided. The terminal may include a reading head, a processor, a keypad and a communications medium. The reading head may be configured to detect, in conjunction with the processor, identification information in response to the swipe of the instrument.

When the identification information is determined by the processor to be associated with a banking identification instrument associated with a financial institution associated with the quick service terminal then the processor may be configured to cause the quick service terminal to initiate an acceptance state.

The acceptance state may be a state for accepting a personal identification number (“PIN”) via the keypad. The PIN may be associated with the banking identification instrument. The computer readable code may also cause the processor to communicate, via the communications medium, the identification information and the PIN to a remote location. The communication may preferably be at least for the purpose of obtaining a session-authorization for the customer associated with the instrument.

When the identification information is determined by the processor to be associated with a personal identification instrument. The processor may be configured to execute a second computer readable program code. The second computer readable program code may include computer readable code for bypassing the acceptance state and performing a search for at least one banking record associated with the personal identification instrument. The computer readable code may also be for terminating the identification session in response to failure to obtain banking records associated with the personal identification instrument.

In addition, the second computer readable code may be configured for receiving a session-auth instruction from a remote location. The session-auth instruction may initiate a banking session in response to identification of the at least one banking record that corresponds to personal identification instrument.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus for use with systems and methods in accordance with the principles of the invention;

FIG. 2 shows another illustrative apparatus for use with systems and methods in accordance with the principles of the invention;

FIG. 3 shows an illustrative platform for use in a banking center;

FIG. 4 shows another illustrative platform for use in a banking center;

FIG. 5 shows an illustrative platform for use as a data center;

FIG. 6 shows still another illustrative platform for use in a banking center;

FIG. 7 shows an elevational view of a conventional QST;

FIG. 8 shows a cut-away side view QST according to certain embodiments;

FIG. 9 shows an elevational view of a QST according to certain embodiments;

FIG. 10 shows a cut-away side view QST shown in FIG. 9; and

FIG. 11 shows an illustrative flow diagram of certain embodiments.

### DETAILED DESCRIPTION OF THE DISCLOSURE

A quick service terminal apparatus, and methods for using same, is provided. The quick service terminal may be configured to identify a customer in response to a swipe of a customer identifying instrument. The identifying instrument may be a driver's license. The identifying instrument may be a government-issued identification card. The identifying instrument may be a banking card associated with a financial institution (“FI”) associated with the terminal. The identifying instrument may be a bank account access card associated with an FI other than the FI associated with the terminal.

In certain circumstances, the bank account access card may also function as a credit card. The bank account access card may also function as a debit card.

The terminal may include one or more reading head(s). The reading head may be disposed in a slot in the terminal. The reading head(s) may be placed, and the slot may be configured, to accept a swipe of the customer-identifying instrument such that the reading head(s) can read information from the customer identifying instrument.

The terminal may include a processor such as a microprocessor. The microprocessor may be in electronic communication with the reading head(s). The terminal may include a keypad. The terminal may include a communications medium for communicating between the microprocessor and a remote location.

The reading head may be configured to detect, in conjunction with the processor, identification information. The identification information may be detected in response to the swipe of the instrument.

When the identification information is determined by the reading head, in conjunction with the processor, to be associated with a banking identification instrument associated with a financial institution associated with the quick service terminal, the processor may configured to execute a first computer readable program code. The first computer readable program code may include computer readable code for causing the quick service terminal to initiate an acceptance state for accepting a personal identification number (“PIN”) via the keypad. The PIN may be associated with the banking identification instrument.

The computer readable code may also be for causing the processor to communicate, via the communications medium, the identification information and/or the PIN to a remote location. Such a remote location may include a central server associated with a branch of the FI. Such a remote location may include a central server associated with multiple branches of the FI. Such a remote location may include a central server associated with multiple ATMs of the FI.

When the identification information is determined by the processor to be associated with a personal identification instrument, the processor may be configured to execute a second computer readable program code. The second computer readable program code may include computer readable code for bypassing the acceptance state. The second computer readable program code may include computer readable code for performing a search for at least one banking record associated with the personal identification instrument.

The second computer readable program code may include computer readable code for terminating the identification session in response to failure to obtain banking records associated with the personal identification instrument.

The second computer readable program code may include computer readable code for receiving a session-auth instruction from a remote location. The session-auth instruction may be for initiating a banking session in response to identification of the at least one banking record that corresponds to the personal identification instrument.

The session-auth instruction may initiate an acceptance state for accepting a personal identification number (“PIN”) via the keypad. The PIN may be associated with the banking identification instrument, although the banking identification instrument has not been presented at the terminal. The PIN may be associated with the personal identification instrument.

In certain embodiments, the processor may be further configured to execute a third computer readable program code. The code may be executed in response to a pre-determined number of failures to obtain banking records associated with the personal identification instrument or in response to some other suitable information or stimuli.

The third computer readable program code may include computer readable code for informing the customer associated with the personal identification instrument that he or she is eligible to open a banking account with the financial institution associated with the quick service terminal.

The third computer readable program code may be for informing the customer associated with the personal identification instrument that he or she has been forgiven a banking service charge in view of his or her multiple swipes at the quick service terminal.

It should be noted that the terminal may include a single slot, with attendant hardware, for reading mag-stripe information from a card. The single slot may also include hardware for reading optical information such as a bar-code. The single slot may include hardware for reading mag-stripe information and optical information. Each of the hardware for reading mag-stripe information and/or the hardware for reading optical information may be in communication with the microprocessor.

It should be noted that the terminal may include two slots. One slot may include hardware for reading mag-stripe information from a card. One slot may include hardware for reading optical information such as a bar-code. Each of the hardware for reading mag-stripe information and/or the hardware for reading optical information may be in communication with the microprocessor.

In certain embodiments, the terminal may be configured, both in hardware and software, to accept identification information that is not associated with the FI that is associated with the terminal.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, the embodiments may be embodied as a method, a data processing system, or a computer program product. Accordingly, the embodiments may take the form of an entirely hardware embodiment, an entirely software embodiment or an embodiment combining software and hardware aspects.

Furthermore, embodiments may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Exemplary embodiments may be embodied at least partially in hardware and include one or more databases, receivers, transmitters, processors, modules including hardware and/or any other suitable hardware. Furthermore, operations executed may be performed by the one or more databases, receivers, transmitters, processors and/or modules including hardware.

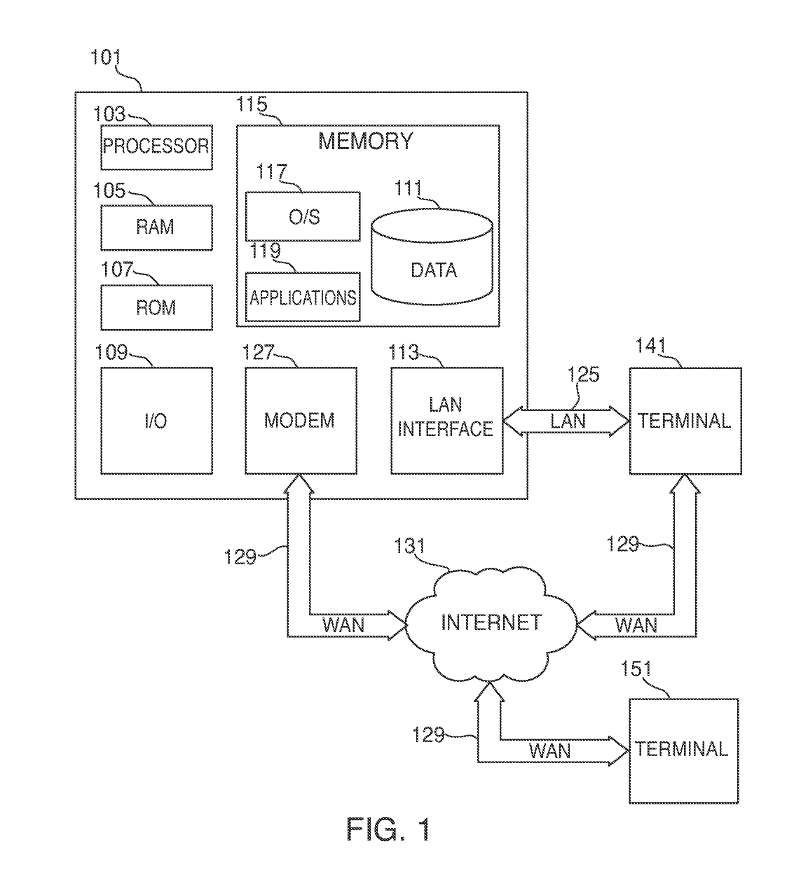

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for information input into one or more of the database(s) described herein, as well as account information, personal identification information, banking identification information, etc.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the embodiments set forth herein. Information input may be stored in memory 115. The input information may be processed by an application such as one of applications 119.

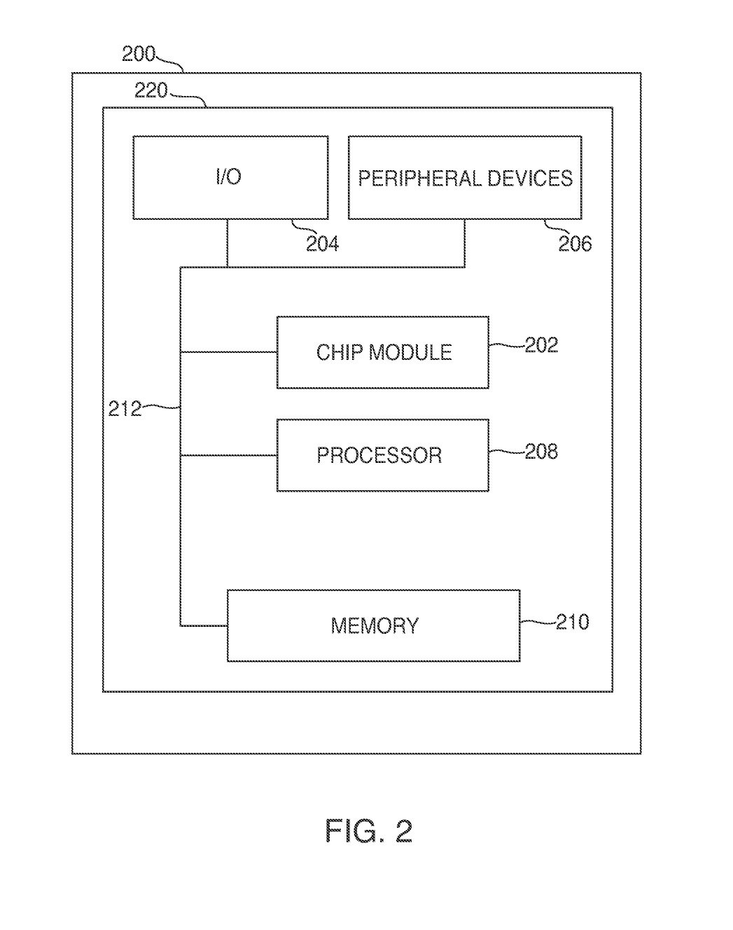

FIG. 2 shows an illustrative apparatus that may be configured in accordance with the principles of the invention.

FIG. 2 shows illustrative apparatus 200. Apparatus 200 may be a computing machine. Apparatus 200 may be included in apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include the transmitter device and the receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device (“processor”) 208, which may compute data structural information, structural parameters of the data and machine-readable memory 210.

Machine-readable memory 210 may be configured to store in machine-readable data structures: data lineage information; data lineage, technical data elements; data elements; business elements; identifiers; associations; relationships; and any other suitable information or data structures.

Components 202, 204, 206, 208 and 210 may be coupled together by a system bus or other interconnections 212 and may be present on one or more circuit boards such as 220. In some embodiments, the components may be integrated into a single silicon-based chip.

Apparatus 200 may operate in a networked environment supporting connections to one or more remote computers via a local area network (LAN), a wide area network (WAN), or other suitable networks. When used in a LAN networking environment, apparatus 200 may be connected to the LAN through a network interface or adapter in I/O circuitry 204. When used in a WAN networking environment, apparatus 200 may include a modem or other means for establishing communications over the WAN. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to operate processor 208, for example over the Internet.

Apparatus 200 may be included in numerous general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, tablets, programmable consumer electronics, network PCs, minicomputers, mainframe computers, distributed computing environments that include any of the above systems or devices, and the like.

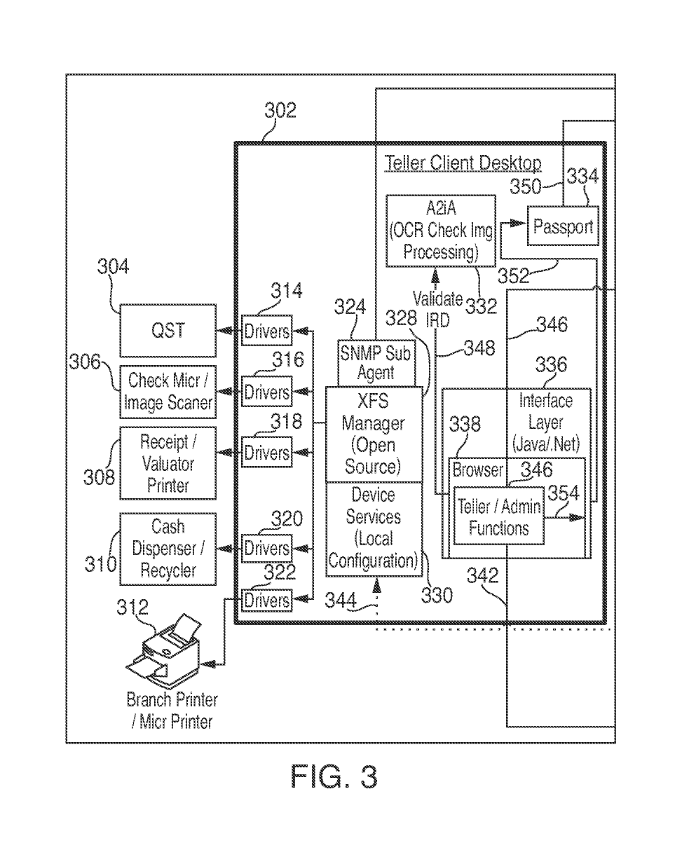

FIGS. 3-6 show an electronic banking platform that may be used to support embodiments of a QST as disclosed herein.

FIG. 3 shows teller client desktop application 302 (hereinafter, “desktop application”) with exemplary components. Desktop application 302 may be located in a banking center. Desktop application 302 may be used by a teller. The teller may perform a transaction for a customer using desktop application 402. Desktop application 302 may include hardware, such as a computer workstation, and software.

In some embodiments, desktop application 302 may also be located at an Automatic Teller Machine (“ATM”). An ATM may be located at a banking center. An ATM may also be located near a banking center, for example, in a banking center parking lot.

Desktop application 302 may include device services (local configuration) 330. device services (local configuration) may enable a user of desktop application 302 to use a shared device. Device services (local configuration) may receive information from device application services (not shown) via communication line 344. The received information may give the user access to specific shared devices.

The received information may also change the permissions of the user to access specific shared devices. It should be appreciated that QST 304, check micr/image scanner 306, receipt/valuator printer 308, cash dispenser/recycler 310 and branch printer/micr printer 312 may be shared devices, which can be accessed by more than one user.

Extensions for financial services (“XFS”) manager 328 may serve as a go-between with drivers 314, 316, 318, 320 and 322, and device services 330. XFS manager may manage the shared devices. XFS manager may also determine how desktop application 302 can and/or should engage with the shared devices.

Device services (local configuration) 330 may communicate with drivers 314, via XFS manager 328. Drivers 314 may provide access to QST 304. QST 304 may be defined as a quick service terminal. A quick service terminal may include a card swipe, a numeric input pad or any other suitable device. Permissions to access the QST may be provided to customers initiating a transaction. The device services (local configuration) 330 may allow for a user to use the QST device, provided that the user is a customer initiating a transaction. In some embodiments, the device services (local configuration) 330 may restrict usage of the QST device to a potential user who has completed a transaction.

Device services (local configuration) 330 may also communicate with drivers 316, via XFS manager 328. Drivers 316 may provide access to check micr/image scanner 306. Permissions to access check micr/image scanner 306 may be provided to a teller engaged in assisting a customer deposit a check. In certain embodiments, check micr/image scanner 306 may be found in Automatic Teller Machines (“ATM”).

Device services (local configuration) 330 may also communicate with drivers 318, via XFS manager 328. Drivers 318 may provide access to receipt/valuator printer 308. Permissions to access the receipt/valuator printer 308 may be determined by device services 330. Permission may be given to a teller, or a customer who prints a receipt of a transaction. Receipt/valuator printer 308 may also be found in an ATM.

Device services (local configuration) 330 may also communicate with drivers 320, via XFS manager 328. Drivers 320 may provide access to cash dispenser/recycler 310. Permissions to access cash dispenser/recycler 310 may be determined by device services. Permissions may be given to a teller, or customer who may deposit, or withdraw, cash during a transaction.

Device services (local configuration) 330 may also communicate with drivers 322, via XFS manager 328. Drivers 322 may provide access to branch printer/micr Printer 312. Permissions to access branch printer/micr printer 312 may be determined by device services. Permissions may be given to a teller, or a customer, who may print a statement.

SNMP (Simple Network Management Protocol) sub agent 324 may be a hardware exception handling protocol. SNMP sub agent may determine or receive notification, when a printer device runs out of paper. SNMP sub agent may also determine or receive notification, when a device jams or a cash dispenser device depleted its cash. SNMP sub agent 324 may communicate with XFS manager. SNMP sub agent may also communicate with XFS (not shown) via communication line 326.

Desktop application 302 may also include browser 338. Browser 338 may allow a user to access the internet—e.g., for the purpose of accessing an online banking service. Desktop application 302 may also include teller/admin functions 340. Teller/admin functions 340 may interact with browser 338 via connection 354. Teller/admin functions 340 may also communicate, via communication line 346, with a branch processor (not shown). Teller/admin functions 340 may also communicate with a teller application server via communication line 342.

Interface layer (Java®/.Net) 336 may enable browser 338 to communicate with the internet by providing the necessary protocols. The protocols used to communicate with browser 338 may be Java®. The protocols used to communicate with browser 338 may be Microsoft® .Net Framework.

Browser 338 may communicate with A2iA (OCR check image processing) 332, via communication line 348. A2iA®, a check image processing company, 332 may validate a check. In order for a check to be validated by A2iA®, the check should preferably include the required components of an IRD document. If A2iA® determines that a check includes the required components of an IRD (“Image Replacement Document”) document, the check may be validated.

When a check is validated, the relevant information may be transmitted to browser 338. The relevant information may then be transferred from browser 338 to interface layer 336. The relevant information may then be transferred from interface layer 336 to passport 334, via communication line 352. Passport 334 may convert the check to an IRD electronic document. Passport 334 may transmit the IRD electronic document to ULZ (“Universal Landing Zone”) (not shown), via communication line 350. Passport 334 may provide a response to interface layer 336 regarding the authorization of the check.

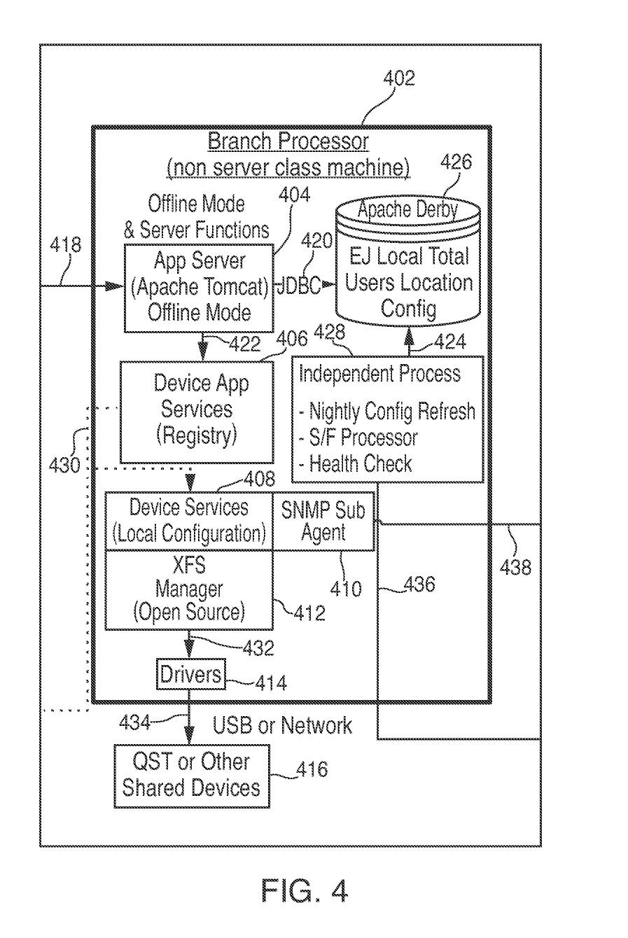

FIG. 4 shows branch processor 402 with exemplary components. Branch processor 402 may include device application services (registry) 406. Device application services (registry) 406 may identify what types of devices are available. Device application services (registry) may also identify what denominations are contained in a cash recycler. Device application services (registry) may also identify how many devices are available, etc. Device application services (registry) 406 may communicate, via communication line 430, with a device services (local configuration) (not shown). Device application services (registry) 406 may also communicate with device services (local configuration) 408, via communication line 430. XFS manager 412 may be a device manager. XFS manager may act as a go-between between the device services (local configuration) 408 and drivers 414, using communication line 432. Drivers 414 may provide access to QST or other shared devices 416, via communication line 434.

Branch processor may also include SNMP sub agent 410. SNMP sub agent 410 may be a hardware exception handler. SNMP sub agent 410 may communicate with extended messaging services (“XMS”) (not shown), via communication line 438.

It should be appreciated that Branch processor 402 includes all the necessary components to execute the tasks performed by a desktop application. These components include device services (local configuration) 408, XFS manager 412, drivers 414 and communication line 434, SNMP sub agent 410 and branch processor 402.

Branch processor 402 may include application server (Apache Tomcat™) offline mode 404. Application server may be a processor which enables branch processor 402 to remain active during service degradation. Application server 404 may have degraded, or offline mode capabilities. These capabilities may include withdrawal of cash, up to a predetermined amount; deposit of checks; and cashing of checks, up to a predetermined amount; and/or any suitable capabilities in degraded mode. Application server 404 may communicate with device application 406, via communication line 422. Application server may receive communications from teller/admin functions (not shown) via communication line 418. Application server 404 may also communicate with Electronic Journal (“EJ”) 426, via protocol Java ® Database Connectivity (“JDBC”) 420.

EJ 426 may record and save substantially all transactions that occur in branch processor 402. The contents of EJ 426 may be transmitted to a data center (not shown) when application server 404 is operated in a degraded mode.

Branch Processor 402 may also include independent process 428. Independent process 428 may monitor the health of the processor itself, as well as perform a nightly configuration refresh. A nightly configuration refresh may be independent process 428 restart and/or reconfigure the processor. Independent process 428 may also communicate with EJ 426, via communication line 424. Independent process 428 may also communicate with a teller application server at a data center (not shown) via communication line 436.

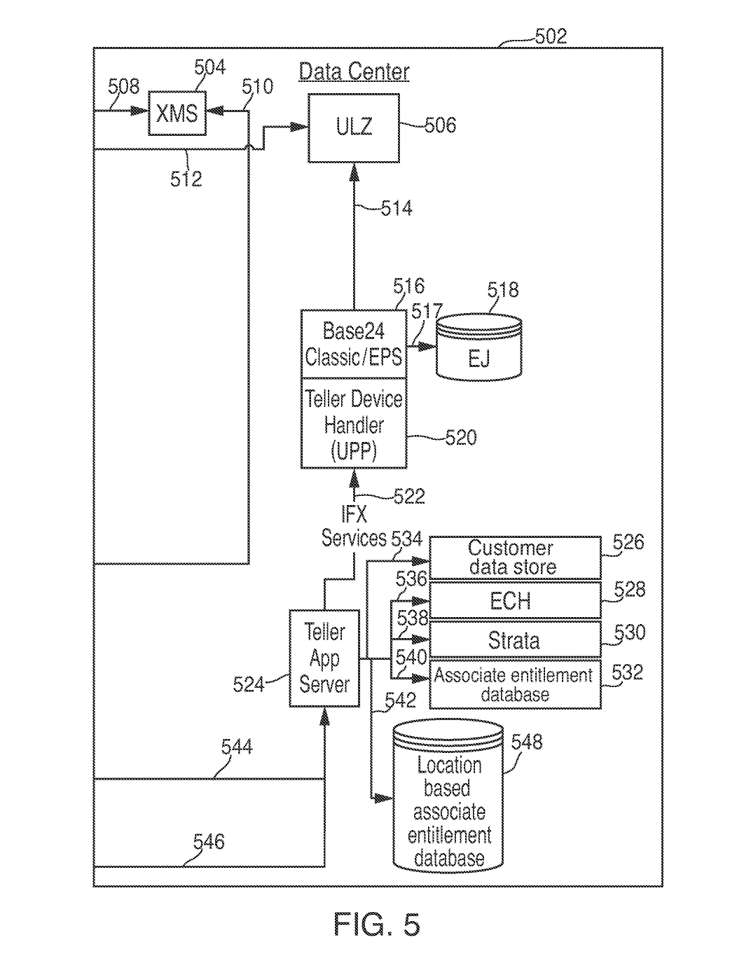

FIG. 5 shows data center 502 with exemplary components. Data center 502 may include XMS 504. XMS 504 may communicate with SNMP, via communication lines 508 and 510. SNMP, as described above, may be located on a desktop application (not shown) or a branch processor (not shown).

Data center 502 may include ULZ 506. ULZ 506 may enable transfer of money between different financial institutions. ULZ may also enable transfer of money within a financial institution. ULZ 506 may receive instructions to transfer money from Passport, via communication line 512. ULZ 506 may also receive IRD documents from passport via communication line 512. Passport may be located on a desktop application, as described above. ULZ may also receive transfer instructions from Base24 Classic/EPS 516 via communication line 514.

Base24 Classic/EPS 516 may be a server. Base24 516 may transmit substantially all transactions to EJ 518 via communication line 517. EJ 518 may record and save substantially all transactions received. Base24 516 may be connected to Teller Device Handler (Universal Payment Platform (“UPP”)) 520. Financial Messaging Protocol (“IFX”) services 522 may be customized to create a customized IFX device handler. A customized IFX device handler may allow for commercial deposits, dozens of check deposits and degraded server mode.

Using conventional UPP tools, IFX services 522 may be transmitted from teller application server 524. Teller application server 524 may be a server. Teller application server 524 may identify the distribution of cash at any given moment at substantially all branch processors and teller client desktops. Communication lines 544 may link branch processors with teller application server 524. Communication lines 546 may link desktop applications with teller application server 524.

Teller application server 524 may communicate with customer data store 526 via communication line 534. Customer Data Store 526 may include the capabilities to identify account information. The account information may be account information which occurred today.

Teller application server 524 may communicate via communication line 536 with Customer Event Hub (“ECH”) 528. ECH 528 may store data for an entire financial institution. Using ECH 528, the teller application server may identify account data regardless of where the transaction occurred.

Teller application server 524 may communicate via communication line 538 with image database (“Strata”) 530. Strata 530 may store images. Strata 530 may also store images regarding signatures of customers. The saved signatures of customers may be used for verification of customer signatures.

Teller application server 524 may communicate with associate entitlement database 532 via communication line 540. Database 532 may include entitlements and identification of associates.

Teller application server 524 may also communicate with location-based associate entitlement database 548 via communication line 542.

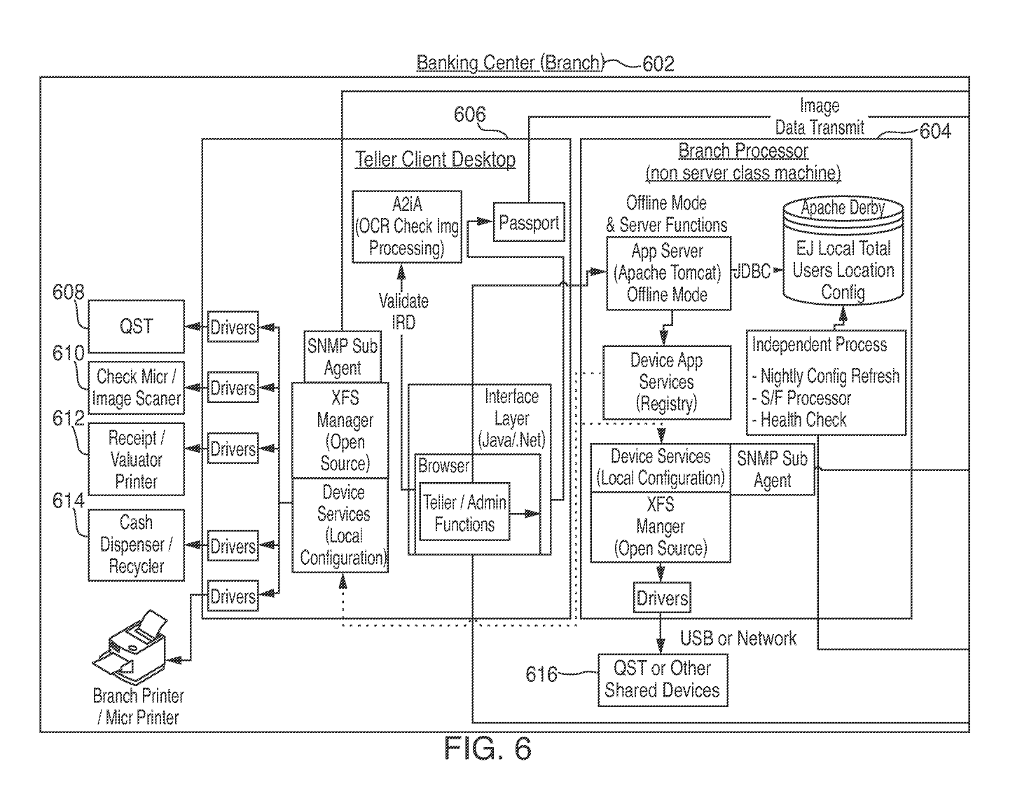

FIG. 6 shows banking center (branch) 602. Banking center (branch) 602 may include branch processor 604. Banking center (branch) 602 may also include desktop application 606. Banking center (branch) 602 may also include shared devices, including QST 606, check micr/image scanner 610, receipt/valuator printer 612, cash dispenser/recycler 614 and QST or other shared devices 616. Banking center (branch) 602 may include more than one branch processor. Banking center (branch) 602 may also include more than one desktop application. The shared devices, as described above, may be used by multiple desktop applications and branch processors in a banking center.

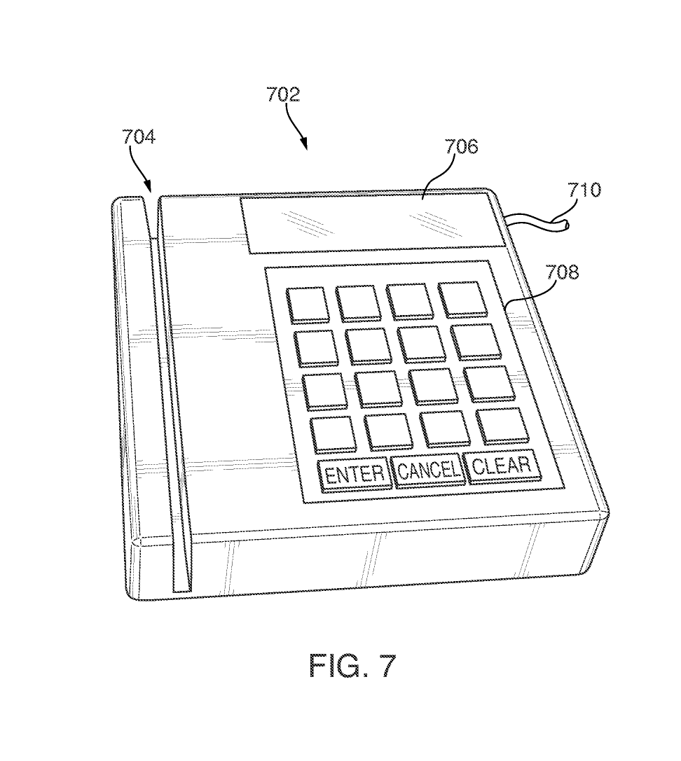

FIG. 7 shows a conventional QST 702. QST 702 may include slot 704, screen 706, input keypad 708 and/or communication line 710.

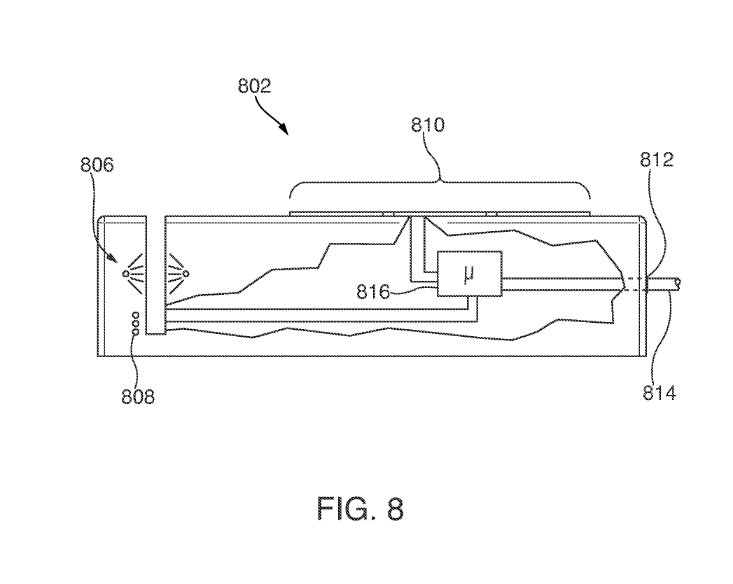

FIG. 8 shows cut-away side view a QST 802 according to certain embodiments. QST 802 may preferably include a slot 804. Slot 804 may house a single side optical reader (not shown) or a dual-sided optical reader 806. Slot 804 may house a mag-stripe reader 808.

A single-sided optical reader or a double-sided optical reader 806 may preferably be configured to read an identification card. Specifically, any suitable optical reader may be configured to read optically recognizable characters and/or one or more codes, such as a bar code, located on the identification card. It should be noted that slot 804 may be used for identification cards with either optically-recognizable indicia and/or magnetically recognizable indicia.

In certain embodiments, the optical reader may be configured to obtain a photo image of at least a portion of the identification card and match the at least a portion of the identification card to a preferably previously-saved portion of the identification card.

QST 802 may also include a keypad input 810 for receiving a keyed input, an I/O port 812 for accommodating communications to and from a communications line 814 and a microprocessor 816. Microprocessor preferably coordinates the signals from each of the component parts of QST 802.

It should be noted that, although mag-stripe reader 808 is shown at a location that is lower than optical reader 806, nevertheless, the scope of the embodiments cover any suitable arrangement of mag-stripe reader 808 and/or optical reader within slot 804.

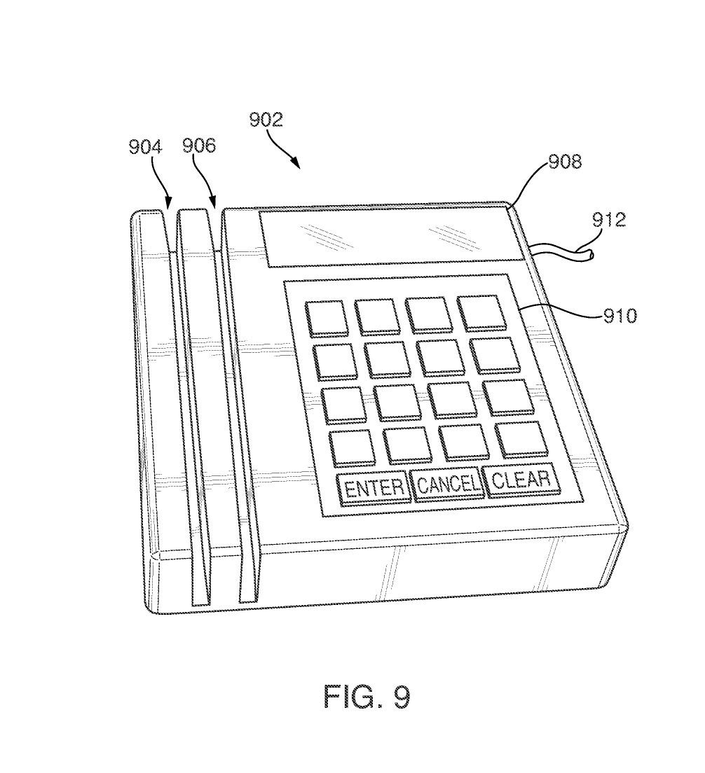

FIG. 9 shows another QST 902 according to certain embodiments. QST 902 preferably includes two slots 904 and 906. In certain embodiments, one of the slots may house an optical reader and one of the slots may house a mag-stripe reader. QST may also include a screen 908, a keypad input 910 and a communications line 912. While the embodiments shown herein are illustrated with a hard-wired communications line, it should be noted that the scope of the invention may also include non-wired communications such as radio frequency communication.

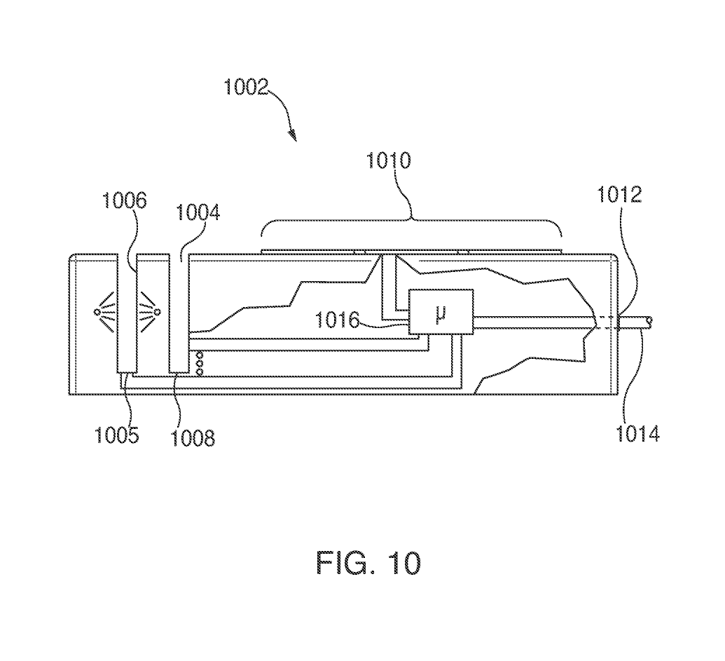

FIG. 10 shows a cut-away side view of a QST 1002 such as the QST shown in FIG. 9. QST 1002 preferably includes a first slot 1004 for housing a mag-stripe reader 1008 and a second slot 1005 for housing an optical reader 1006 (which is shown as being a dual-sided optical card reader, but may also be a single-sided optical card reader.) QST 1002 also may include a keypad input 1010, an I/O port 1012, a communications line 1014 and a microprocessor 1016.

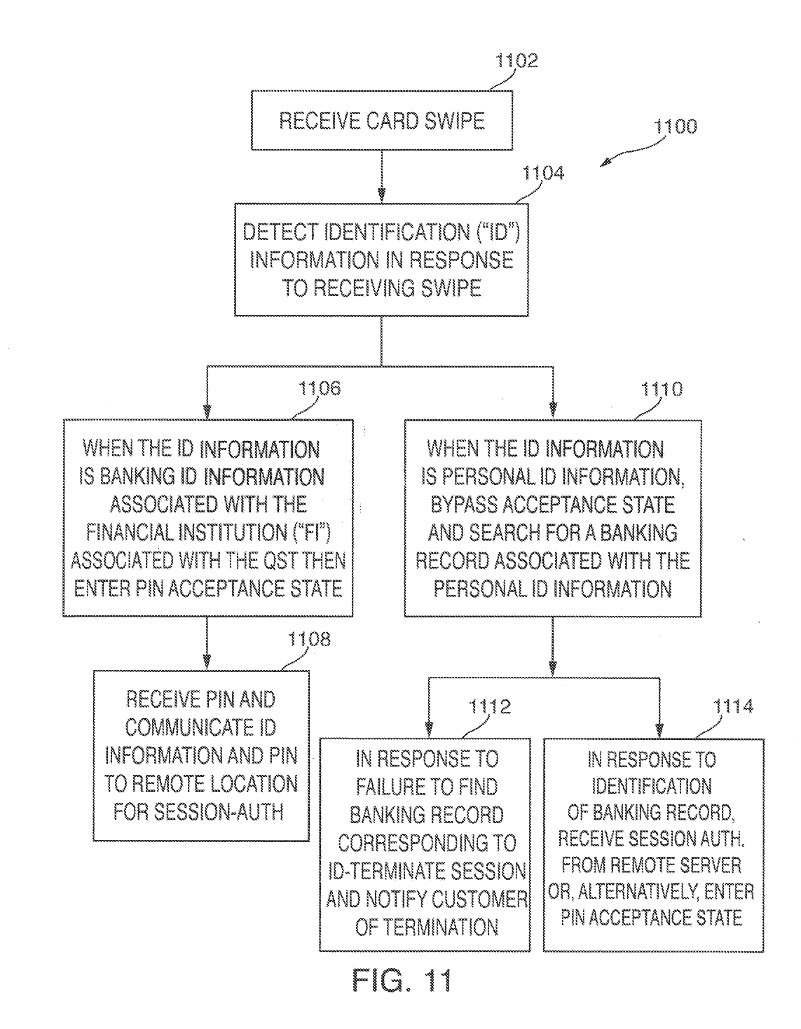

FIG. 11 shows an illustrative flow diagram 1100 of embodiments of implementing a QST. At 1102, the QST may receive a card swipe. The card swipe may be from either a banking ID card or a personal ID card. The card swipe may be in a QST having a single slot. The card swipe may be in a QST having two slots.

At step 1104, the QST, either by itself or in conjunction with other software and/or hardware (such as, inter alia, XFS manager 328, SNMP and Sub Agent 324 shown in FIGS. 3 and 6, APP Server 404 shown in FIG. 4) shown schematically in FIGS. 3-6, may detect ID information in response to receiving the swipe.

At step 1106, when the ID information is banking ID information associated with the financial institution (“FI”) associated with the QST, then the QST may enter a pin acceptance state. In the pin acceptance state, the QST may preferably be configured to accept a pin input into the keypad input, as shown in step 1108, and to communicate ID information and PIN to a remote location for session authorization (“session-auth”) (or to make the session-auth decision locally to the QST).

At step 1110, when the ID information is personal ID information, the QST may bypass a pin acceptance state and request from other software and/or hardware shown schematically in FIGS. 3-6, including, but not limited to XMS 512, to search for a banking record associated with at least a portion of the personal ID information.

Step 1112 shows that, in response to a failure to find a banking record corresponding to the personal ID information, the QST may terminate the session and notify the customer—e.g., by flashing a termination notification on the QST screen.

Step 1114 shows that, in response to identification of a banking record corresponding to the personal ID information, the QST may receive a session-auth from a remote server (or, in the alternative, generate a session-auth locally) or enter a pin acceptance state which may require input of a pin that corresponds to a banking card associated with the banking record that corresponds to the personal ID information.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage encoded media including memory storage device.

One of ordinary skill in the art will appreciate that the elements shown and described herein may be performed in other than the recited order and that one or more elements illustrated may be optional. The methods of the above-referenced embodiments may involve the use of any suitable elements, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, apparatus for, and methods for using, a quick service terminal have been provided. Persons skilled in the art will appreciate that the present invention can be practiced in embodiments other than the described embodiments, which are presented for purposes of illustration rather than of limitation, and that the present invention is limited only by the claims that follow.

1. A quick service terminal that is configured to identify a customer in response to a swipe of a customer identifying instrument, the terminal comprising:
an optical reading head and a magnetic reading head, wherein both the optical reading head and the magnetic reading head share a single slot in the quick service terminal, and wherein the optical reading head is disposed on a first side of the slot and the magnetic reading head is disposed on a second side of the slot;
a processor;
a keypad; and
a communications medium;
wherein the optical reading head is configured to receive light signals to detect, in conjunction with the processor, identification information in response to the swipe of the instrument, and the magnetic reading head is configured to receive magnetic signals to detect, in conjunction with the processor, the identification information in response to the swipe of the instrument;
wherein, when the identification information is determined by the processor to be associated with a banking identification instrument associated with a financial institution associated with the quick service terminal, the processor is configured to execute a first computer readable program code;
the first computer readable program code comprising:
computer readable code for causing the quick service terminal to initiate an acceptance state for accepting a personal identification number (“PIN”) via the keypad, said PIN associated with the banking identification instrument; and
computer readable code for causing the processor to communicate, via the communications medium, the identification information and the PIN to a remote location;
wherein, when the identification information is determined by the processor to be associated with a personal identification instrument, the processor is configured to execute a second computer readable program code;
the second computer readable program code comprising:
computer readable code for bypassing the acceptance state and performing a search for at least one banking record associated with the personal identification instrument;
computer readable code for terminating the identification session in response to failure to obtain banking records associated with the personal identification instrument;
computer readable code for receiving a session-auth instruction from a remote location, said session-auth instruction for initiating a banking session in response to identification of the at least one banking record that corresponds to personal identification instrument.

2. The terminal of claim 1, wherein the personal identification instrument is a government-issued driver's license.

3. The terminal of claim 1, wherein the personal identification instrument is a government-issued driver's license.

4. The terminal of claim 1, wherein the personal identification instrument is a bank account access card issued to a bank account resident at a financial institution other than the financial institution associated with the quick service terminal.

5. The terminal of claim 1, wherein, when the personal identification instrument is a bank account access card issued to a bank account resident at a financial institution other than the financial institution associated with the quick service terminal, the processor is configured to execute a third computer readable program code;
the third computer readable program code comprising:
computer readable code for causing the quick service terminal to initiate an acceptance state for accepting a personal identification number (“PIN”) via the keypad, said PIN associated with the bank account access card.

6. The terminal of claim 1, wherein the processor is further configured to, in response to a pre-determined number of failures to obtain banking records associated with the personal identification instrument, execute a third computer readable program code;
the third computer readable program code comprising:
computer readable code for informing the customer associated with the personal identification instrument that he or she is eligible to open a banking account with a financial institution associated with the quick service terminal.

7. The terminal of claim 1, wherein the processor is further configured to, in response to a pre-determined number of failures to obtain banking records associated with the personal identification instrument, execute a third computer readable program code;
the third computer readable program code comprising:
computer readable code for informing the customer associated with the personal identification instrument that he or she has been forgiven a banking service charge in view of his or her multiple swipes at the quick service terminal.

8. A quick service terminal that is configured to identify a customer in response to a swipe of a customer identifying instrument, the terminal comprising:
an optical reading head and a magnetic reading head, wherein the optical reading head is disposed in a first slot in the terminal and the magnetic reading head is disposed in a second slot in the quick service terminal, wherein the first slot is different from the second slot;
a processor;
a keypad; and
a communications medium;
wherein the reading head is configured to detect, in conjunction with the processor, the identification information, in response to the swipe of the instrument, the identification information to be associated with a personal identification instrument, and the processor is further configured to execute a computer readable program code;
the computer readable program code configured to:
bypass the acceptance state and performing a search for at least one banking record associated with the personal identification instrument;
receive a session-auth instruction from a remote location, said session-auth instruction for initiating a banking session in response to identification of the at least one banking record that corresponds to the personal identification instrument; and
terminate the identification session in response to failure to obtain a banking record associated with the personal identification instrument.

9. The terminal of claim 8, wherein the personal identification instrument is a government-issued identification card.

10. The terminal of claim 8, wherein the personal identification instrument is a government-issued driver's license.

11. The terminal of claim 8, wherein the personal identification instrument is a bank account access card issued to a bank account resident at a financial institution other than the financial institution associated with the quick service terminal.

12. The terminal of claim 8, wherein, when the personal identification instrument is a bank account access card issued to a bank account resident at a financial institution other than the financial institution associated with the quick service terminal, the processor is configured to execute a second computer readable program code;
the second computer readable program code configured to:
cause the quick service terminal to initiate an acceptance state for accepting a personal identification number (“PIN”) via the keypad, said PIN associated with the bank account access card.

13. The terminal of claim 8, wherein the processor is further configured to, in response to a pre-determined number of failures to obtain banking records associated with the personal identification instrument, execute a second computer readable program code configured to;
electronically notify the customer associated with the personal identification instrument that he or she is eligible to open a banking account with a financial institution associated with the quick service terminal.

14. The terminal of claim 8, wherein the processor is further configured to, in response to a pre-determined number of failures to obtain banking records associated with the personal identification instrument, execute a second computer readable program code;
the second computer readable program code configured to:
notify the customer associated with the personal identification instrument that he or she has been forgiven a banking service charge in view of his or her pre-determined number of swipes at the quick service terminal.

15. A method for identifying a customer in response to a swipe of a customer identifying instrument, the method for use on a quick service terminal, the terminal comprising an optical reading head and a magnetic reading head, wherein both the optical reading head and the magnetic reading share a single slot in the quick service terminal and wherein the optical reading head is disposed on a first side of the slot and the magnetic reading head is also disposed on the first side of the slot, a processor, a keypad and a communications medium, the method comprising:
using either the optical reading head or the magnetic reading head to detect, in conjunction with the processor, identification information in response to the swipe of the instrument;
when the identification information is determined by the processor to be associated with a banking identification instrument associated with a financial institution associated with the quick service terminal, using the processor to cause the quick service terminal to initiate an acceptance state for accepting a personal identification number (“PIN”) via the keypad, the PIN associated with the banking identification instrument, and using the processor to communicate, via the communications medium, the identification information and the PIN to a remote location;
when the identification information is determined by the processor to be associated with a personal identification instrument, using the processor to bypass the acceptance state and perform a search for at least one banking record associated with the personal identification instrument, using the processor to terminate the identification session in response to failure to obtain banking records associated with the personal identification instrument, and using the processor to receive a session-auth instruction from a remote location, the session-auth instruction for initiating a banking session, in response to identification of the at least one banking record that corresponds to the personal identification instrument.

16. The method of claim 15, wherein the personal identification instrument a government-issued driver's license.

17. The method of claim 15, wherein the personal identification instrument is a government-issued driver's license.

18. The method of claim 15, wherein the personal identification instrument is a bank account access card issued to a bank account resident at a financial institution other than the financial institution associated with the quick service terminal.

19. The method of claim 15, wherein, when the personal identification instrument is a bank account access card issued to a bank account resident at a financial institution other than the financial institution associated with the quick service terminal, the method further comprises using the processor is to cause the quick service terminal to initiate an acceptance state for accepting a personal identification number (“PIN”) via the keypad, said PIN associated with the bank account access card.

20. The method of claim 15 further comprising using the processor to, in response to a pre-determined number of failures to obtain banking records associated with the personal identification instrument, notify the customer associated with the personal identification instrument that the customer is eligible to open a banking account with a financial institution associated with the quick service terminal.

21. The method of claim 15 further comprising using the processor to, in response to a pre-determined number of failures to obtain banking records associated with the personal identification instrument, notify the customer associated with the personal identification instrument that the customer has been forgiven a banking service charge in view of his or her multiple swipes at the quick service terminal.
